(19) United States
(12) Patent Application Publication
(10) Pub. No.: US 2018/0133997 A1
(43) Pub. Date: May 17, 2018

(54) TABLETING MACHINE HAVING A DEVICE FOR EXECUTING A DASHBOARD APPLICATION

(71) Applicant: Korsch AG, Berlin (DE)

(72) Inventors: Arno Rathmann, Bernau (DE); Walter Hegel, Berlin (DE)

(73) Assignee: Korsch AG, Berlin (DE)

(21) Appl. No.: 15/567,766

(22) PCT Filed: Apr. 20, 2016
(86) PCT No.: PCT/EP2016/058777

§ 371 Date: Oct. 19, 2017

(30) Foreign Application Priority Data
Apr. 20, 2015 (DE) 10 2015 106 012.4
Jun. 11, 2015 (DE) 20 2015 103 051.7

(51) Int. Cl. B30B 11/00; G05B 19/04; G07C 3/08; A61J 3/10

(52) U.S. Cl. CPC B30B 11/005; A61J 3/10; G07C 3/08; G05B 19/04

(57) ABSTRACT

The invention relates to a tableting machine with a device for executing a dashboard application, wherein information present stored in the tableting machine can be visualized by means of the dashboard application, wherein the dashboard application is a software product which can be run on a device for executing the dashboard application, which is selected from a group comprising mobile and/or stationary communication devices and/or data processing devices, wherein the device for executing the dashboard application and the tableting machine comprise means for setting up an information exchange connection, by means of which the information can be exchanged between the tableting machine and the device for executing the dashboard application. The invention further relates to a method for executing a dashboard application for monitoring and/or controlling a tableting machine.

The invention relates to a tableting machine with a device for executing a dashboard application. The invention further relates to a method for executing a dashboard application for monitoring and/or controlling a tableting machine. In the prior art, tableting machines are known, which comprise, for example, a rotary press for manufacturing tablets, which typically comprise a rotor. Said rotor comprises a set of lower punches and upper punches which work together in dies or die holes of a die table of the rotor, in such a manner that a powdered starting material is pressed between the pressing punches to form a pellet, for example, a tablet. Usually, the control and movement of the pressing punch occurs by cam segments and pressing rolls. The dies or die holes are filled by means of a stationary filling device with the powder to be processed. The ejection of the finished pellet occurs with the aid of the lower punch, which moves upward when the upper punch has been removed, so that the resulting pellet above the upper edge of the matrix die table is removed from the rotor area by a stripping device.

Usually, the production of pellets is overseen by a user or operator who is simultaneously responsible for the proper operating procedure of one or more tableting machines, for example, in a machine shop. It has been shown that it is a practical necessity to provide possibilities so that the user or operator can monitor the operating procedure of tableting machines even from a greater distance or when absent from the production site, in which case it would be desirable, for example, to be able to reliably inspect the operating data of the tableting machine from outside. In the sense of the invention, the terms “tableting machine” and “tablet machine” are preferably to be used synonymously.

In recent years, it has become common that the tableting machines are increasingly networked, wherein usually two basic types of networking are used. Some tableting machines use the infrastructure of existing IT systems, for example, in order to store data in a predetermined folder to access a network printer in order to print out the generated protocols there. Other tableting machines enable a data exchange between a Production Planning System (PPS) or a Manufacturing Execution System (MES).

Today, for process reasons, it is still conventional to produce the tablets in batches. Each process step proceeds individually, and only when a sample of the tablets produced is examined and has been found to be satisfactory is the next process step instituted. Although it is not yet common, it is foreseeable that continuous production methods will be introduced in the future. To make this possible, modern tableting machines are usually provided with a PC by means of which data can be collected and processes can be visualized. For this purpose, in the prior art, Human Machine Interface (HMI) displays or operating consoles are used, in order to document the current operating state of the tableting machine and to allow interventions in the operation.

A disadvantage of the HMI displays used to date or of conventional operating consoles is that they can be adapted only by qualified specialized personnel to individual change requests which necessitate, in particular, a programming knowledge that an average user of a tableting machine does not have. In addition, to date, many conventional display methods merely allow the display of text lines, wherein the individual lines are often kept very small in order to be able to execute the displays in a particularly space saving manner. As a result, the use of a conventional tableting machine using display devices that are common so far is made very difficult particularly for elderly or vision-impaired employees.

Another disadvantage of conventional tableting machines consists in that, so far, information on the cost effectiveness and productivity of the installations was not a priority for the operator and, to date, such information was obtained only at a later time if at all. However, this information is useful for the optimal use of the tableting machines, and it would therefore be desirable to be able to represent such data as well in such a manner that it can be inspected in a clear and easily accessible way.

Also, in the case of conventional tableting machines, online transmission of status messages, for example, in the case of malfunctions of the tableting machine, is provided only if the tableting machine is connected to a production planning system or an MES system. Another disadvantage is that, in conventionally operating tableting machines, usually the only data that is evaluated is data that is of interest for the current operating situation and the currently produced tablets.

Accordingly, the aim of the present invention consists in providing a tableting machine which does not have the disadvantages and the deficiencies of the prior art and in which the operating data can be inspected from a mobile communication device or a data processing device, independently of the networking of the tableting machine. Here, this inspection should occur in a reliable and tamper-proof manner and as flexibly as possible for the user.

According to the invention, the aim is achieved by a tableting machine with a device for executing a dashboard application, wherein information that is present stored in the tableting machine can be visualized by means of the dashboard application, wherein the dashboard application is a software product which can be run on a device for executing the dashboard application, which is selected from a group comprising mobile and/or stationary communication devices and/or data processing devices, wherein the device for implementing the dashboard application and the tableting machine comprise means for the setup of an information exchange connection, by means of which information can be exchanged between the tableting machine and the device for implementing the dashboard application.

In the sense of this invention, the term “stored” is understood to mean that the corresponding data, which is preferably stored in the tableting machine, can be retrieved by the dashboard application. For this purpose, it can be preferable that the tableting machine comprises means for storing or processing data, such as, for example, a data storage or a processor. It can also be preferable that the data can be retrieved only for a short time in the tableting machine and that it is overwritten with more current data after the expiration of a predetermined time interval. In the sense of this invention, such data that is available for only a short time should also be considered “stored.” The visualized representation of such data that is available for a short time is advantageous, particularly since, as a result, not only static data but also dynamic parameters that change as a function of time can be represented by means of the device for executing a dashboard application. In particular, in this way. changes of data or parameters can also be represented. The average person skilled in the art knows that especially data and parameter changes are particularly significant for operating a tableting machine, as a result of which, by the use of a dashboard application, it is also possible to access such data that in the past could not be displayed or represented with conventional tableting machines. Tests have shown that dashboard applications in connection with tableting machines are particularly suitable for displaying surprisingly extensive and/or unforeseeable changes of data and/or parameters rapidly and, in particular, in a manner that is intuitively understandable to the user of a tableting machine, who can thus react swiftly to these changes.

In the sense of the present invention, a dashboard application is preferably a software program product that uses means for visualizing information. The dashboard application according to the invention comprises, for example, a graphic user interface in order to represent information in a user-defined manner in overviews, graphics, diagrams and/or other compilation forms. The average person skilled in the art knows how information that relates, for example, to the operating data of a tableting machine, can be represented. It is preferable that the device for executing a dashboard application comprises a display device which is selected from a group comprising a display, a display table, a screen and/or a touch screen. Preferably, such a device for executing a dashboard application also comprises a processor on which the dashboard application can be executed. It is preferable that the information that is necessary for the user of a tableting machine for normal operation and effective management of the pellet manufacturing process is visualized on the device for executing the dashboard application by means of the display device. An essential advantage of a dashboard application consists in that changes that need to be made can be made without software and programming knowledge, and that, in particular, no changes of the source code are necessary. Such changes can consist, for example, of a changed selection of data, or of a changed manner of representation and/or visualization.

The device for executing the dashboard application and the tableting machine comprise in each case means for setting up an information exchange connection, by means of which the information can be exchanged between the tableting machine and the dashboard application. Thus, the user or operator of the tableting machine can advantageously access information that has been deposited or stored in the tableting machine, without having to be physically close to the tableting machine. By means of the dashboard, information can advantageously be represented with several tableting machines simultaneously on one dashboard or separately on several dashboards. In addition, due to the accessibility of the tableting machine information, several tableting machines can also be monitored simultaneously, for example, if the dashboard application is run on a central computer in a machine shop and, for example, the information of several tableting machines is visualized with one or more dashboard applications.

In the sense of the invention, it can be preferable to configure the dashboard application in such a manner that the visualizing of the information of several tableting machines occurs in one dashboard application, which is particularly advantageous if information is to be compared to one another in order to be able to better plan the further operation of the tableting machine ahead of time and monitor it. In the sense of the invention, it can also be preferable to use a separate dashboard application for each tableting machine. As a result, the clarity of the representation can be improved surprisingly considerably in comparison to conventional HMI displays or operating consoles, and the assignment of individual tableting machines to a corresponding dashboard application is simplified.

It is preferable that the user of the dashboard application, after the installation thereof on the mobile and/or stationary communication device or data processing device, configures the dashboard application for his purposes and requirements, i.e., that he performs a setting and selects the information that he considers appropriate and necessary for the operation of the tableting machine. A mobile communication device in the sense of the invention is, for example, a mobile telephone, a smartphone, a Palm device and/or a tablet PC, without, however, being limited thereto. A stationary communication device in the sense of the invention is, for example, a device for the purpose of communication, which is preferably designed so as not to be mobile, i.e., in the sense of the invention, so as to be portable and/or transportable.

It was entirely surprising that the user does not need to perform any programming work when using a dashboard application according to the invention. Rather, it is preferable that the information of interest is selected by the user and then displayed on the display device, wherein the selection can occur, for example, by marking, clicking and/or dragging. The average user knows the ways information can be selected using displays, display tables, screens and/or touch screens.

Advantageously, the use of the dashboard application occurs independently of an operating system of the mobile communication device and/or of the data processing device. As a result, the dashboard application can surprisingly be run both on Apple and Mac products as well as on Android products in different versions and apparatus types, as well as, for example, under the operating systems Windows and/or Linux-based operating systems on a PC and/or a notebook. In addition, the dashboard application is completely separate from and independent of the selection of the hardware and/or software platform, for example, PCs, smartphones, tablets and/or laptops with different operating systems.

A surprising advantage of the device for executing the dashboard application is that the user himself can adapt the data determined in the desired representation format, without having programming knowledge and abilities for this purpose. As a result, a high user friendliness of the tableting machine as well as of the dashboard application is ensured. In particular, since no programming knowledge on the part of the user is thus required, the inhibition threshold for the utilization of the tableting machine and for the use of the dashboard is considerably reduced.

Another advantage of the device for executing the dashboard application consists in that, advantageously, no source code has to be changed. This is advantageous, since, as a result, there is no need to repeat the qualification and/or validation during each use, in order to demonstrate the plausibility of the data. As a result, redundant work steps are avoided. In particular, this considerably simplifies the compliance with the requirements of the Food and Drug Administration (FDA) of the US public health authority.

In another preferred embodiment of the invention, the information that is present stored in the tableting machine consist of operating data of the tableting machine, which are selected from a group comprising current operating time, current pressing time, up-to-date data, recipe data and/or efficiency data. In particular, this is data that is necessary for the operation of the tableting machine or makes important information about the tableting machine available to the user. Here, the data can be, for example, data showing the time of the expected production end of the tableting machine according to the invention and/or the frequency at which pellets are currently produced. In addition, for example, recipe data and/or efficiency data can also be stored in the tableting machine.

In this context, in particular, several different recipe data sets could not be stored, retrieved and/or visualized simultaneously for individual tableting machines in the past, and therefore it was very cumbersome in the past to compare, for example, two or more recipe data sets with one another. Advantageously, the dashboard application according to the invention enables a particularly clear and readily understandable representation of the data. Furthermore, in the past, data on cost effectiveness and/or productivity in connection with conventional tableting machines was not displayed, since, as derived parameters, it was moreover often not available to the user of the tableting machine at the desired time. Tests have shown that the device for executing a dashboard application in connection with a tableting machine is particularly well-suited for displaying both derived and also non-derived data and/or parameters.

It is also preferable to store data concerning the correct assembly of different tableting machine components in the tableting machine. The tableting machine, for example, can only be started if, at each position of the tableting machine, the correct component for the manufacture of a certain pellet is present arranged at the position intended for that purpose. Here, the transmission of the position and component data can occur in a contact-based and/or wired manner, preferably by means of transponders. For example, if the components of the tableting machine are present in labeled and/or coded form, then the code can be read using the camera of the smartphone, for example, and in this way the incorporated part can be identified. The possibility of visual representation of the position and/or component data enables a particularly rapid finding of assembly errors of the tableting machine and thus shortens undesired standstill times of the tableting machine.

It is preferable that the information stored in the tableting machine comprises both directly readable values and also derived values. Directly readable values are, for example, the current operating time of the tableting machine, the current pressing time of the tableting machine, additional current data and/or recipe data. They can be displayed directly by the tableting machine without additional calculations, wherein the dynamics of these parameters, i.e., the change of these parameters over time, can advantageously also be displayed. As a result, the user advantageously receives valuable information about the operation of the tableting machine and can better plan ahead and control the use thereof. For example, the derived parameters are efficiency data which can be calculated, for example, from the known number of the pellets to be produced or by the disclosure of the lot size of a batch taking into consideration previous reasons for stopping the tableting machine.

Another advantage of the device for executing the dashboard application consists in that, for example, in the case of a malfunction, the person in charge of maintaining the tableting machine can be informed particularly rapidly and in a targeted manner, so that he can give the operator of the tableting machine more precise information in order to correct the malfunction. As a result, advantageously, malfunction-caused down times of the tableting machine are shortened, and the average productivity of the tableting machine is increased over its useful life.

For example, based on the achieved hours of operation of the tableting machine, it is also possible that the person in charge of maintenance can deduce whether and/or when maintenance work has to be carried out on the tableting machine. In addition, the device according to the invention also provides the person in charge of maintenance with particularly rapid and extensive information on the manner in which the maintenance and/or cleaning work is to be carried out. This work can therefore be planned better, which is advantageous for the person in charge of maintenance, since he can obtain information in a particularly simple and inexpensive manner on the given production status and the operating state of the tableting machine. This simplicity is ensured advantageously in that the device for executing the dashboard application interacts, for example, with mobile communication devices of the type available to many individuals or private households, and which the users thereof generally like to use. As a result, the time spent with data made available by the dashboard application is surprisingly not perceived by a user, who on the contrary gladly performs this work, as payable work, leading to particularly frequent inspection of the data made available by the dashboard application, which results in a particularly reliable monitoring of the operating data of the tableting machine.

In a particularly preferred embodiment, the information exchange connection is selected from a group comprising an Internet connection, QR technology, barcode technology, near field technology, network-capable protocols, LAN connection and/or WLAN connection. It is preferable that the access by means of the device for executing the dashboard application occurs with the aid of an IP address, so that the tableting machine is available as data source for the operating data. The use of an IP address is particularly advantageous if the tableting machine is integrated in a (W)LAN. Advantageously, the connection establishment is thus not limited to mobile communication devices such as smartphones and/or tablets, but instead is also possible with a stationary PC, a notebook and/or a laptop. In the sense of the present invention, the tableting machine can preferably be referred to as a data hotspot. This means preferably that, in the sense of the invention, the information or operating data is present stored in the tableting machine and can be retrieved by a user by means of the different preferred technologies.

It is preferable that the mobile communication devices and/or data processing devices access the operating data and/or information provided by the tableting machine, for example, via a web server or network variables, wherein the communication advantageously can also occur via network-capable protocols such as, for example, via OPC and future technologies. OPC unified architecture, in the sense of the invention, denotes an industrial machine-to-machine communication protocol which, advantageously, is capable not only of transporting machine data (process values, measured values, parameters, etc.), but also of describing them semantically in a machine-readable form. Here, the services made available in the context of OPC are advantageously protocol-independent, wherein the OPC information model preferably represents a so-called Full Mesh network made of nodes, by means of which meta and diagnostic information can also advantageously be visualized. In the sense of the present invention, a node preferably denotes an object from the object-oriented programming. Furthermore, it is preferable to define events which can be sent, for example, in order to exchange certain information between the tableting machine and the device for executing the dashboard application. Advantageously, an authentication, authorization, encoding and/or data integrity occur by signing.

In another preferred embodiment of the invention, the tableting machine comprises use of an infrastructure of the mobile and/or stationary communication devices. In the sense of the invention, the infrastructure of the mobile and/or stationary communication devices comprises, for example, the camera, the microphone, the display, input devices and/or inputs for electrical and/or data connections, without being limited thereto. As a result, the user of the dashboard application according to the invention can advantageously also use the infrastructure of the mobile and/or stationary communication device, without being forced to procure and/or use expensive additional equipment and modules. As a result, the handling of the device for executing the dashboard application is considerably simplified and designed in a cost-effective and user-friendly manner.

In another preferred embodiment of the invention, the mobile communication devices and the data processing devices are selected from a group comprising mobile telephones, smartphones, tablets, notebooks, laptops and/or PCs. Advantageously, a dashboard application can be provided, which can be operated not only on mobile communication devices such as tablets or smartphones, for example, but also with computer assistance, on notebooks and/or PCs, for example. Thus, the dashboard application according to the invention can also be run, for example, on a smartphone which can be connected via Internet to the tableting machine, as a result of which, advantageously, an external access to the operating data of the tableting machine becomes possible.

For example, in this manner, a user of the tableting machine who works at home for a day, for example, can access the operating data of the tableting machine if necessary, and exchange views about this data with the on-site operator. As a result, modern work time models become possible, which is considerably useful, for example, for young parents, as well as for elderly employees who take care of relatives, for example.

However, the dashboard application can also be run just as well on a stationary PC set up, for example, in a production shop where several tableting machines are located, and from which the dashboard applications of several machines can be inspected simultaneously or successively. Thus, the use of the dashboard application makes available a wide range of applications and fields of use and enables a flexible handling of the operating data of the tableting machine. Another advantage of the use of a dashboard application in connection with a tableting machine consists in that a considerably improved exploitation of existing IT infrastructure is achieved, as a result of which procurement costs in this field can be reduced substantially.

For some application cases, it can be preferable for the operator of the tableting machine to be able identify the error in a particularly simple and rapid manner by means of the dashboard application, for example, in the case of a malfunction, in order to provide a more effective and better targeted remedy than in the past with the conventional tableting machines known from the prior art. In particular, the operator can use the infrastructure of an available or provided smartphone, for example, the camera and/or the microphone, for photographs, videos and audio recordings or also for reading a code by means of which, for example, the malfunctioning components are optionally marked. As a result, the service technician gains a better understanding of the situation of the tableting machine on site. Then, particularly targeted instructions can be given to the operator, in order to solve the problem particularly effectively and in a short time.

In another preferred embodiment, the dashboard application comprises graphic user interfaces and/or menus. By the use of graphic user interfaces, on the one hand, users who have little experience with the operation of a tableting machine are addressed, for example, persons in training. It has been shown advantageously that the visualization possibilities of graphic user interfaces intrinsically motivate the users to familiarize themselves with the operating data and the mode of operation of the tableting machine, so that the dashboard application according to the invention is particularly suitable for teaching and training purposes in order to provide an introduction to the handling of a tableting machine. For the technically well-versed user, the use of graphic user interfaces also represents an attractive tool, since he recognizes such graphic forms of representation, for example, from graphics-based software products (for example, Labview) for programming interfaces between work computers and technical installations. It was entirely surprising that, using the dashboard application, the entire spectrum can be followed by different users in a particularly pleasing manner.

In the sense of the present invention, menus preferably allow the representation of text-oriented information which, if needed, can be selected by a user for display with a dashboard application. Graphic user interfaces comprise, for example, overviews, graphs, diagrams and/or compilation and representation forms of data and/or parameters.

A use of the dashboard application consists, for example, in making available one or more menus which provide, for example, in the calibration of the tableting machine, the information necessary for the configuration of the tableting machine. If a dashboard application according to the invention is used for starting up a tableting machine, the user advantageously does not have to perform any programming work. Instead, preferably, the user downloads the dashboard application as software product on a mobile communication device and/or data processing device and then selects, in a user-based and flexible manner, the information and/or operation data of the tableting machine which he considers necessary or desirable for operating the tableting machine. This data is then dragged into the screen, preferably in the forms of graphs, diagrams and/or overviews. Advantageously, this ensures high variability, simplicity and user friendliness. When using the dashboard application in the context of a tableting machine, a special advantage results particularly from the fact that a dashboard application does not have a fixed syntax and can therefore be adapted particularly simply to individual needs.

The advantage of a dashboard application according to the invention, in comparison to a standard programming as used in conventional tableting machines, consists in that, in the dashboard application, the user himself can set up and design menus, graphic user interfaces and/or content overviews depending on findings and need, and, in addition, can determine which data is to be displayed in which overview and/or in which menu. Application tests have shown that changes with regard to this assignment can be carried out particularly simply, whereby a flexible adaptation to external changes during the operation of the tableting machine is guaranteed. Moreover, the source code does not have to be changed due to the changed assignment of data to menus and/or content overviews, so that no programming knowledge on the part of the user or the employment of a programmer specifically for this purpose is needed. In contrast, in the case of standard programs described in the prior art, the contents and/or menus are linked in a fixed manner with the displayed data, so that the contents and/or menus cannot be changed as desired in terms of content or newly assigned.

In another preferred embodiment, the information for visualization on the device for executing the dashboard application can be selected by a user. This means that, in the sense of the present invention, a user of the tableting machine according to the invention, for example, selects once the operating data that he considers necessary henceforth for operating the tableting machine and which is to be visualized by means of the device for executing the dashboard application.

In the sense of the present invention, it is preferable that this selection occurs once before the startup of the tableting machine. It can just as well be preferable that different users, who alternately manage the tablet manufacturing process, for example, for the same employer, select different operating data for visualization on the device for executing the dashboard application, because, for example, they have different focuses in monitoring the pellet manufacturing process. Application tests have shown that, by the individual selectability of the information and operating data that are to be visualized, high flexibility and a surprisingly high adaptivity of the dashboard application are made provided for the user of the tableting machine.

An additional application possibility of a dashboard application consists in that the data to be visualized with the dashboard is preferably not calculated but instead is transmitted from the tableting machine and/or from a server to the dashboard application. The average person skilled in the art knows that numerous variables are needed for controlling and/or visualizing this process of the tableting machine. It is preferable that the dashboard application accesses this group of variables, which can be supplemented, for example, by variables that in the past were not relevant to the user with conventional tableting machines. This data consists, for example, of results of an efficiency calculation or of the determination of when a tableting machine under current production conditions has reached a targeted production quantity, so that a next process step can take place. Additional data needed for determining maintenance intervals or maintenance objectives, for example, in the past could already be displayed by means of conventional HMI displays or operating consoles and are therefore advantageously also available for visualization by means of the dashboard application. For example, the operator can access this data in order to establish when the gear oil needs to be replaced, for example.

In another preferred embodiment, the dashboard application is present stored on the tableting machine, on a server, on a database, in a cloud and/or in a drop box. In the sense of the invention, it is particularly preferable that the dashboard application is only available for users who have qualified, by the purchase of a tableting machine according to the invention, for the access to the dashboard application according to the invention, whereby these users obtain, for example, a coded access to the dashboard application. In the sense of the invention, it is preferable that the dashboard application can be downloaded as software product from a server, a database, a cloud and/or a drop box, or that the dashboard application is present on the tableting machine itself.

In a particularly preferable embodiment of the invention, the data displayed by means of the dashboard application is stored in the tableting machine. Advantageously, the use of the dashboard technology also makes it possible to access not an individual tableting machine but centrally a database, if the latter has been stored, for example, in a production planning or ME system.

In another preferred embodiment of the invention, the information in the tableting machine is stored in a Manufacturing Execution System (MES) format. It is preferable that the data processing and collection represents a subset of an ME system. Advantageously, such an ME system elaborates functions by Historian, which is advantageous particularly for the provision of maintenance data.

It is preferable that the MES comprises a process-oriented operating level which acquires all the data of the tableting machine. By means of this information, it is advantageously possible to synchronize the different sub-processes needed for producing pharmaceutical products in a particularly simple and user-friendly manner and to coordinate them using surprisingly efficient and synergistic effects. It is preferable that information can be further processed during the ongoing process for the downstream activities, wherein this information represents, for example, tableting machine events such as, for example, standstill or delayed completion of the production.

An additional essential aim that can be achieved by connecting the dashboard application to an MES is the regulation and/or release of the tableting machine for persons authorized to work on the tableting machine. For example, it can be preferable that a central password is issued, which is known exclusively to the authorized persons, wherein the issuing of authorizations is managed centrally, for example, authorizations for the machine operator and/or the user for the different tableting machines and the different function levels to which an operator or a user has access. Application tests have shown that above all the input of changes of such authorizations can occur particularly rapidly and easily. Such changes can result, for example, from the fact that an employee leaves an enterprise or advances or descends to a modified authorization level. It has been shown that, by means of the device for executing a dashboard application, in particular a considerably faster barring of access becomes possible, which can occur preferably at a central site for all the tableting machines.

Furthermore, it is preferable to use the device for executing a dashboard application for the planning the production for subsequent days, i.e., to provide recipes according to which the production is to take place henceforth. For this purpose, the MES advantageously provides the possibility of storing the recipes no longer individually, separately on each tableting machine, but instead of managing, testing and/or releasing the recipes, centrally for example. Each tableting machine preferably works only with those recipes that were procedurally released for this concrete tableting machine. In addition, the surprising advantage is achieved that, with the device for executing a dashboard application in connection with an MES, it is possible to control entire process chains, installations and/or factories and to control and/or optimize the operation thereof.

In an additional embodiment, the invention relates to a method for executing a dashboard application for monitoring and/or controlling a tableting machine, comprising the following steps:

a) providing a device for executing the dashboard application, on which the dashboard application is present installed

b) providing the tableting machine

c) storing information about the tableting machine on the tableting machine

d) setting up an information exchange connection between the tableting machine and the device for executing the dashboard application

e) transferring information about the tableting machine to the device for executing the dashboard application

f) visualizing the information about the tableting machine with the aid of the dashboard application.

In particular, technical features that were disclosed for the tableting machine according to the invention with a device for executing a dashboard application also apply to the method according to the invention. The average person skilled in the art recognizes that, in particular, features of the preferred embodiments of the tableting machine with a device for executing a dashboard application can also be used for the implementation of the method according to the invention. For example, for the tableting machine according to the invention with a device for executing a dashboard application, it is disclosed that it comprises, in a preferred embodiment, means for setting up an information exchange connection, selected from a group comprising QR technology, barcode technology, near field technology, network-capable protocols, LAN connection and/or WLAN connection. The person skilled in the art thus recognizes that, in the method according to the invention too, the transfer of the information occurs preferably by a QR technology, barcode technology, near field technology, network-capable protocols, LAN connection and/or WLAN connection. The advantages disclosed for preferred embodiments of the tableting machine with a device for executing a dashboard application thus preferably also apply to the corresponding preferred embodiments of the method according to the invention. Therefore, the method preferably uses the tableting machine according to the invention with a device for executing a dashboard application or preferred embodiments thereof.

In particular, by means of the method using a dashboard application according to the invention, it is advantageously possible to select in a particularly simple manner which information about the tableting machine is displayed. Thus, advantageously, no software or programming knowledge is required for a configuration or change of the dashboard application for visualizing certain information. Due to the use of a dashboard application, the method is particularly flexible and user-friendly, in contrast, for example, to methods using hard coded software applications.

In a preferred embodiment of the invention, the method is characterized in that the information consists of operating data of the tableting machine and is selected from a group comprising current running time, current pressing time, up-to-date data, recipe data and/or efficiency data. This preferred data is particularly useful for monitoring or controlling the operation of the tableting machine.

In a particularly preferred embodiment of the invention, the method is characterized in that the storage of the information about the tableting machine occurs in a Manufacturing Execution System format. As explained for the preferred tableting machine with a device for executing a dashboard application, the Manufacturing Execution System format is particularly suitable for storing information and parameters about tablet manufacturing processes and for providing said information and parameters for further processing. As a result, a surprisingly rapid synchronization of the current operating data about the tableting machine on the dashboard application is possible. This allows a particularly effective monitoring of ongoing processes as well as the adaptation thereof during the ongoing manufacturing process.

In a preferred embodiment of the invention, the method is characterized in that, for executing the dashboard application, an authentication of the user occurs. An authentication preferably denotes a process step which establishes whether the user is authorized to monitor and/or control the tableting machine. For example, for this purpose, a password query can occur on the device before starting the dashboard application. If the password entered by the user matches a centrally stored password for the corresponding tableting machine, the dashboard application is executed, otherwise access is denied. It can also be preferable that, by means of the authentication, a limited release occurs, whereby only selected data released for the user is visualized. By means of a linking of the dashboard application according to the invention with an authentication of the user, a particularly flexible and secure monitoring of the operating processes of the tablet machine is made possible.

In a preferred embodiment of the invention, the method is characterized in that, on the device for executing the dashboard application, at least two dashboard applications are present installed, and by means of a first dashboard application, information about a first tableting machine is visualized, and, by means of a second dashboard application, information about a second tableting machine is displayed. Advantageously, in this preferred embodiment of the method, it is possible in a particularly effective manner to monitor a plurality of tableting machines with the aid of a single device for executing a dashboard application—for example, a smartphone. This has a particularly advantageous effect on the monitoring and process optimization of factories for manufacturing pharmaceutical products.

The invention is described in further detail in reference to embodiment examples and the following figures, showing:

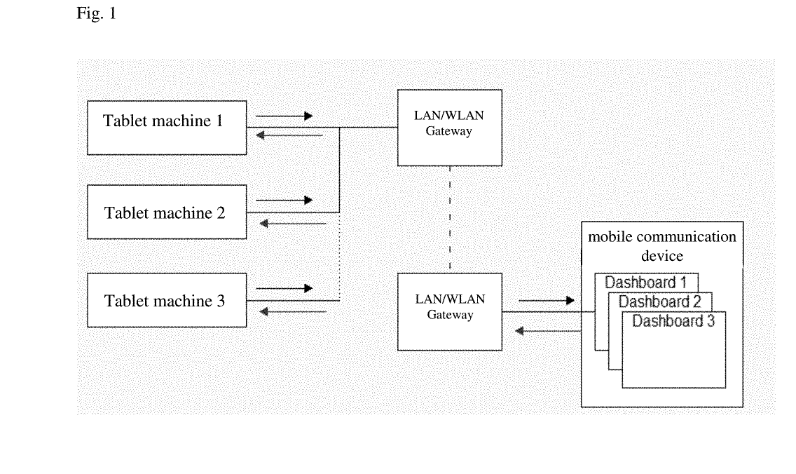

FIG. 1: flow diagram

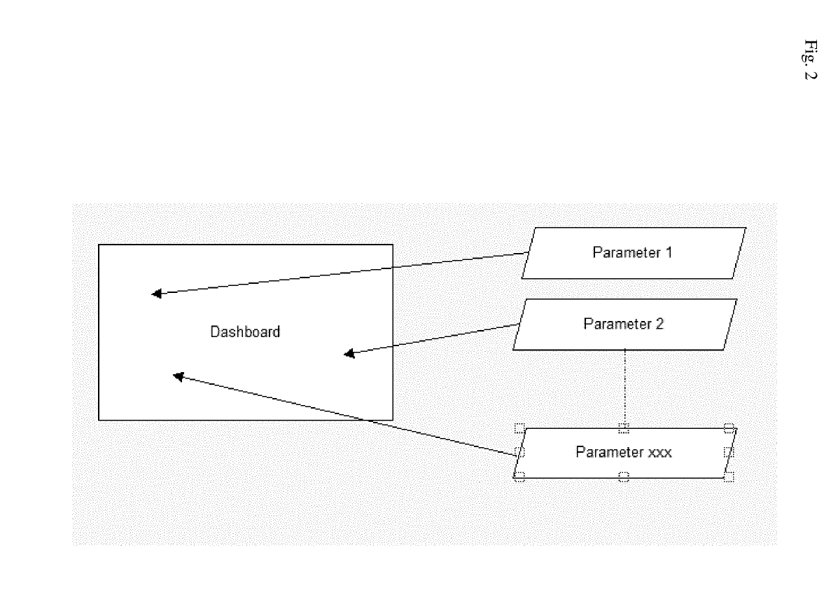

FIG. 2: data selection

FIG. 1 shows a flow diagram of a preferred embodiment of the invention. In this preferred embodiment, three tableting machines 1, 2 and 3 can be seen, which are connected by a LAN/WLAN and/or gateway to a mobile communication device. In the preferred embodiment of the invention that is shown, the mobile communication device comprises three dashboard applications 1, 2 and 3, on which, for example, different data of the tableting machine can be displayed. The pairs of arrows shown at several sites in the figure, which point in different directions in each case, are intended to symbolize the data exchange which can occur between one of the tableting machines and/or the mobile communication device. The arrows pointing in different directions here symbolize particularly that data is exchanged both in one direction and the other.

For example, FIG. 2 shows how a data selection can be carried out by means of a preferred embodiment of the invention. This data consists, in particular, of data that can be visualized by means of the dashboard application. An undetermined quantity of parameters 1, 2, . . . , xxx, is represented, wherein each parameter can be selected individually, in order to be visualized by means of the dashboard application. For other applications, it is also preferable to select only a subset of all the parameters 1 to xxx present and have them be visualized. The arrows pointing from the individual parameters to different areas of the rectangle marked with the word dashboard indicate that each parameter can be visualized at different sites in a menu or a content overview of the dashboard application, wherein the design of such a content overview and/or menu can be carried out surprisingly simply with the aid of a dashboard application.

It is pointed out that different alternatives to the described embodiments of the invention can be used in order to carry out the invention and arrive at the solution according to the invention. The tableting machine according to the invention with a device for executing a dashboard application or the method according to the invention is thus not limited in terms of the designs to the above preferred embodiments. Instead, a plurality of design variants which can deviate from the represented solution is conceivable. The aim of the claims is to define the scope of protection of the invention. The protective scope of the invention is intended to encompass the tableting machine according to the invention with a device for executing a dashboard application or the method according to the invention as well as equivalent embodiments thereof.

1. A tableting machine with a device for executing a dashboard application,
wherein information that is present stored in the tableting machine can be visualized using the dashboard application,
wherein the dashboard application is a software product which can be run on the device for executing the dashboard application,
wherein the device for executing the dashboard application, of the tableting machine, is selected from a group of devices consisting of mobile devices, stationary communication devices, and data processing devices,
wherein the device for executing the dashboard application and the tableting machine comprise means for setting up an information exchange connection, by which the information can be exchanged between the tableting machine and the device for executing the dashboard application, and
wherein the dashboard application is stored on the tableting machine, a server, a database in a cloud and/or a drop box.

2. The tableting machine according to claim 1, wherein the information consists of operating data of the tableting machine and includes one or more types of information selected from a group consisting of current running time, current pressing time, up-to-date data, recipe data, and efficiency data.

3. The tableting machine according to claim 1, wherein the information exchange connection is one or more types of connections selected from a group consisting of an Internet connection, QR technology, barcode technology, near field technology, network-capable protocols, LAN connection, and WLAN connection.

4. The tableting machine according to claim 1, wherein the tableting machine uses an infrastructure of the mobile and/or stationary communication devices.

5. The tableting machine according to claim 1, wherein the mobile communication devices and/or data processing devices, of the group from which the device for executing the dashboard application is selected, include one or more of a mobile telephone, a smartphone, a tablet, a laptop, a notebook and/or a PC.

6. The tableting machine according to claim 1, wherein the dashboard application comprises graphic user interfaces and/or menus.

7. The tableting machine according to claim 1, wherein the information for visualizing on the device for executing a dashboard application can be selected by a user.

8. The tableting machine according to claim 1, wherein the information is present stored in the tableting machine in a Manufacturing Execution System format.

9. A method for executing a dashboard application for monitoring and/or controlling a tableting machine, the method comprising:
a) providing a device for executing the dashboard application, on which the dashboard application is installed,
b) providing the tableting machine,
c) storing information about the tableting machine on the tableting machine,
d) setting up an information exchange connection between the tableting machine and the device for executing the dashboard application,
e) transferring information about the tableting machine to the device for executing the dashboard application, and
f) visualizing the information about the tableting machine with the aid of the dashboard application.

10. The method according to claim 9, wherein the information comprises one or more types of operating data of the tableting machine selected from a group consisting of current running time, current pressing time, up-to-date data, recipe data and/or efficiency data.

11. The method according to claim 9, wherein the storing of the information about the tableting machine comprises storing the information in a Manufacturing Execution System format.

12. The method according to claim 9, further comprising:
authenticating the user for executing the dashboard application.

13. The method according to claim 9, wherein:
on the device for executing the dashboard application, at least two dashboard applications are installed,
the dashboard application is a first dashboard application of the at least two dashboard applications,
the tableting machine is a first tableting machine,
visualizing the information about the first tableting machine comprises, using the first dashboard application, visualizing information about the first tableting machine, and
the method further comprises visualizing, using a second dashboard application of the at least two dashboard applications, information about a second tableting machine.
